(19) United States
(12) Patent Application Publication
(10) Pub. No.: US 2023/0330530 A1
(43) Pub. Date: Oct. 19, 2023

(54) PROP CONTROL METHOD AND APPARATUS IN VIRTUAL SCENE, DEVICE, AND STORAGE MEDIUM

(71) Applicant: Tencent Technology (Shenzhen) Company Limited, Shenzhen (CN)

(72) Inventors: Siyi YAN, Shenzhen (CN); Mingwei ZOU, Shenzhen (CN); Guanlin HUANG, Shenzhen (CN); Hengshun ZHAN, Shenzhen (CN); Qi ZHAO, Shenzhen (CN); Xu WANG, Shenzhen (CN); Jingxuan CHEN, Shenzhen (CN); Jiakai CHEN, Shenzhen (CN); Zihan ZHOU, Shenzhen (CN); Ru XIAO, Shenzhen (CN)

(21) Appl. No.: 18/213,109

(22) Filed: Jun. 22, 2023

Related U.S. Application Data
(63) Continuation of application No. PCT/CN2022/116877, filed on Sep. 2, 2022.

(30) Foreign Application Priority Data
Sep. 28, 2021 (CN) 202111141285.7

(51) Int. Cl. A63F 13/52; A63F 13/533; A63F 13/537

(52) U.S. Cl. CPC A63F 13/52; A63F 13/533; A63F 13/537; A63F 13/577

(57) ABSTRACT

A prop control method in a virtual scene is performed by a computer device. The method includes: displaying a first scene picture of the virtual scene, the first scene picture including a first virtual object and a scene element; when a distance between the first virtual object and the scene element in the virtual scene meets a predefined condition, receiving a prop pull operation for the scene element by the first virtual object; and in response to the prop pull operation for the scene element, controlling the first virtual object pull a target virtual prop corresponding to the scene element closer to the first virtual object. By using the foregoing method, when a user controls a virtual object to interact with a virtual prop, the power consumption and data usage of a computer device is reduced.

### CROSS-REFERENCE TO RELATED APPLICATIONS

This application is a continuation application of PCT Patent Application No. PCT/CN2022/116877, entitled “PROP CONTROL METHOD AND APPARATUS IN VIRTUAL SCENE, DEVICE, AND STORAGE MEDIUM” filed on Sep. 2, 2022, which claims priority to Chinese Patent Application No. 202111141285.7, entitled “PROP CONTROL METHOD AND APPARATUS IN VIRTUAL SCENE, DEVICE, AND STORAGE MEDIUM” filed on Sep. 28, 2021, all of which is incorporated by reference in its entirety.

### FIELD OF THE TECHNOLOGY

This application relates to the technical field of virtual scenes, and in particular, to a prop control method and apparatus in a virtual scene, a device, and a storage medium.

### BACKGROUND OF THE DISCLOSURE

Currently, in some game-type applications, such as first person shooting (FPS) games, various virtual props are typically provided, whereby players control virtual objects to interact with the virtual props, for example, pick up the virtual props, or interact with the virtual props.

In the related art, the virtual props are typically scattered throughout a virtual scene, for example, placed on the ground in the virtual scene, or stored within a container in the virtual scene. The players may control the virtual objects to approach the virtual props, and may control the virtual objects to interact with the virtual props, for example, pick up the virtual props, or interact with the virtual props when the virtual props are within an interaction range of the virtual objects.

### SUMMARY

Embodiments of this application provide a prop control method and apparatus in a virtual scene, a device, and a storage medium, which can improve the human-computer interaction efficiency when a user controls a virtual object to interact with a virtual prop, shorten the duration of a single battle, and reduce the power consumption and data usage of a computer device. The technical solutions are as follows.

According to one aspect, an embodiment of this application provides a prop control method in a virtual scene performed by a computer device. The method includes:
displaying a first scene picture of the virtual scene, the first scene picture including a first virtual object and a scene element;
when a distance between the first virtual object and the scene element in the virtual scene meets a predefined condition, receiving a prop pull operation for the scene element by the first virtual object; and
in response to the prop pull operation for the scene element, controlling the first virtual object pull a target virtual prop corresponding to the scene element closer to the first virtual object.

According to another aspect, an embodiment of this application provides a computer device. The computer device includes a processor and a memory. The memory stores at least one computer instruction. The at least one computer instruction is loaded and executed by the processor, whereby the computer device implements the prop control method in the virtual scene as described in the foregoing aspect.

According to another aspect, an embodiment of this application provides a non-transitory computer-readable storage medium. The non-transitory computer-readable storage medium stores at least one computer instruction. The at least one computer instruction is loaded and executed by a processor, whereby a computer implements the prop control method in the virtual scene as described in the foregoing aspect.

According to the technical solutions provided in the embodiments of this application, when a scene element other than a first virtual object in a virtual scene corresponds to a virtual prop, a target virtual prop corresponding to the scene element may be pulled closer to the first virtual object by performing a prop pull operation, thereby reducing time required by a user to control the first virtual object to approach the target virtual prop, whereby the first virtual object can interact with the virtual prop more quickly. Therefore, the human-computer interaction efficiency when the user controls the virtual object to interact with the virtual prop is greatly improved, thereby shortening the duration of a single battle, and reducing the power consumption and data usage of a computer device.

### BRIEF DESCRIPTION OF THE DRAWINGS

FIG. 1 is a schematic diagram of an implementation environment according to an exemplary embodiment of this application.

FIG. 2 is a schematic diagram of a display interface of a virtual scene according to an exemplary embodiment of this application.

FIG. 3 is a flowchart of a prop control method in a virtual scene according to an exemplary embodiment of this application.

FIG. 4 is a flowchart of a prop control method in a virtual scene according to an exemplary embodiment of this application.

FIG. 5 is a schematic diagram of skill icon display in the embodiment of FIG. 4.

FIG. 6 is a schematic diagram of a reference-type interaction in the embodiment of FIG. 4.

FIG. 7 is a schematic diagram of prompt information display in the embodiment of FIG. 4.

FIG. 8 is a schematic diagram of virtual prop pull in the embodiment of FIG. 4.

FIG. 9 is a schematic diagram of virtual prop pull in the embodiment of FIG. 4.

FIG. 10 is a control flowchart of virtual prop pull according to an exemplary embodiment.

FIG. 11 is a block diagram of a prop control apparatus in a virtual scene according to an exemplary embodiment of this application.

FIG. 12 is a structural block diagram of a computer device according to an exemplary embodiment of this application.

FIG. 13 is a structural block diagram of a computer device according to an exemplary embodiment of this application.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of apparatuses and methods that are described in detail in the appended claims and that are consistent with some aspects of this application.

It is to be understood that “a plurality of” mentioned in the specification means one or more, and “multiple” means two or more. “And/or” describes an association relationship between associated objects, and represents that three relationships may exist. For example, A and/or B may represent the following three cases: Only A exists, both A and B exist, and only B exists. The character “/” generally represents that contextual objects are in an “or” relationship.

To facilitate understanding, the following explains terms involved in this application.

### 1) Virtual Scene

The virtual scene is a virtual scene displayed (or provided) when an application is run on a computer device. The virtual scene may be a simulated environment scene of a real world, a semi-simulated semi-fictional three-dimensional environment scene, or a purely fictional three-dimensional environment scene. The virtual scene may be any one of a two-dimensional virtual scene, a 2.5-dimensional virtual scene, and a three-dimensional virtual scene. The following embodiments are illustrated as the virtual scene being a three-dimension virtual scene, but are not limited thereto. In some embodiments, the virtual scene may also be used for a virtual scene battle between at least two virtual characters. In some embodiments, the virtual scene may also be used for combating a battle using a virtual firearm between at least two virtual characters. In some embodiments, the virtual scene may also be used for combating a battle using a virtual firearm between at least two virtual characters within a target region range. The target region range may be reduced over time in the virtual scene. In some embodiments, the virtual scene may also be referred to as a virtual environment, a virtual world, or the like.

The virtual scene is typically generated by an application in a computer device such as a terminal, and displayed based on hardware (such as a screen) in the terminal. The terminal may be a mobile terminal such as a smartphone, a tablet computer or an e-book reader. Or, the terminal may be a personal computer device such as a laptop computer or a desktop computer.

### 2) Virtual Object

The virtual object refers to a movable object in the virtual scene. The movable object may be at least one of a virtual person, a virtual animal, and a virtual carrier. In some embodiments, when the virtual scene is a three-dimensional virtual scene, the virtual object is a three-dimensional stereo model created based on animated skeleton technology. Each virtual object has a corresponding shape, volume and orientation in the three-dimensional virtual scene, and occupies a portion of space in the three-dimensional virtual scene.

### 3) Virtual Prop

The virtual prop refers to a prop available for the virtual object in the virtual environment, including a virtual weapon, a supply prop, a virtual pendant installed on a specified virtual weapon and providing partial attribute additions for the virtual weapon, and a defense prop. Or, the virtual prop may correspond to resource props of one or more resources. Or, the virtual prop may be a task prop for performing one or more tasks.

### 4) FPS Game

The FPS game refers to a shooting game which can be played by a user from a first-person perspective. A picture of a virtual environment in the game is a picture in which the virtual environment is observed from the perspective of a first virtual object. In the game, at least two virtual objects perform a single battle mode in the virtual environment, and the virtual objects achieve the purpose of survival in the virtual environment by avoiding injuries initiated by other virtual objects and hazards (such as toxic gas circles and swamps) existing in the virtual environment. When the life value of the virtual objects in the virtual environment is zero, the life of the virtual objects in the virtual environment ends. In some embodiments, an arena mode of the battle may include a single-player battle mode, a double-player group battle mode, or a multiplayer group battle mode. The battle mode is not limited in the embodiments of this application.

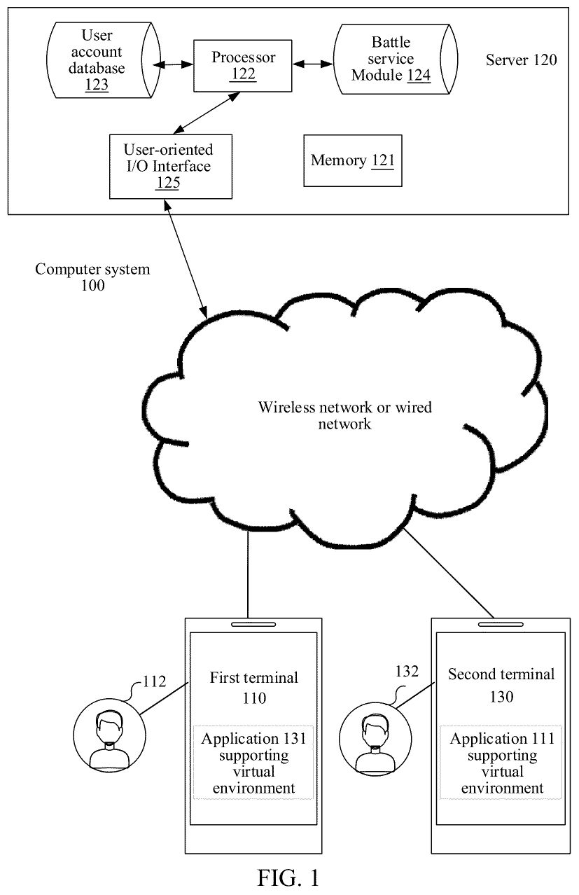

FIG. 1 shows a schematic diagram of an implementation environment according to an exemplary embodiment of this application. The implementation environment may include a computer system 100. The computer system 100 includes: a first terminal 110, a server 120, and a second terminal 130.

An application 111 supporting a virtual environment is installed and run in the first terminal 110, and the application 111 may be a multiplayer online battle program. When the first terminal 110 runs the application 111, a user interface of the application 111 is displayed on a screen of the first terminal 110. The application 111 may be any one of a multiplayer online battle arena (MOBA) game, a shooting game, and a simulation game (SLG). In this embodiment, the application 111 is illustrated by being a FPS game. The first terminal 110 is a terminal used by a first user 112. The first user 112 uses the first terminal 110 to control activities of a first virtual object located in a virtual environment. The first virtual object may be referred to as a master virtual object of the first user 112. The activities of the first virtual object include, but are not limited to, at least one of adjusting body posture, crawling, walking, running, riding, flying, jumping, driving, picking up, shooting, attacking, throwing, and skill casting. Exemplarily, the first virtual object is a first virtual person, such as a simulated person or an animated person.

An application 131 supporting a virtual environment is installed and run in the second terminal 130, and the application 131 may be a multiplayer online battle program. When the second terminal 130 runs the application 131, a user interface of the application 131 is displayed on a screen of the second terminal 130. The application 131 may be any one of a MOBA game, an escape shooting game, and a SLG. In this embodiment, the application 131 is illustrated by being a FPS game. The second terminal 130 is a terminal used by a second user 132. The second user 132 uses the second terminal 130 to control activities of a second virtual object located in the virtual environment. The second virtual object may be referred to as a main control virtual character of the second user 132. Exemplarily, the second virtual object is a second virtual person, such as a simulated person or an animated person.

In some embodiments, the first virtual object and the second virtual object are in the same virtual world. In some embodiments, the first virtual object and the second virtual object may belong to the same camp, the same team and the same organization, have a friend relationship, or have a temporary communication permission. In some embodiments, the first virtual object and the second virtual object may belong to different camps, different teams and different organizations, or have an adversarial relationship.

In some embodiments, the applications installed on the first terminal 110 and the second terminal 130 are the same, or the applications installed on the two terminals are the same type of applications on different operating system platforms (Android or IOS). The first terminal 110 may generally refer to one of a plurality of terminals, and the second terminal 130 may generally refer to another of the plurality of terminals. This embodiment is exemplified only by the first terminal 110 and the second terminal 130. The first terminal 110 and the second terminal 130 have the same or different device types. The device types include: a smartphone, a tablet computer, an e-book reader, a moving picture experts group audio layer III (MP3) player, a moving picture experts group audio layer IV (MP4) player, a laptop computer, and a desktop computer.

Only two terminals are shown in FIG. 1. However, in different embodiments, there are multiple other terminals having access to the server 120. In some embodiments, there are also one or more terminals corresponding to a developer. A development and editing platform for an application supporting a virtual environment is installed on the terminal. The developer may edit and update the application on the terminal, and transmit an updated application installation package to the server 120 through a wired or wireless network. The first terminal 110 and the second terminal 130 may download the application installation package from the server 120 to implement the update of the application.

The first terminal 110, the second terminal 130, and the other terminals are connected to the server 120 through the wireless network or the wired network.

The server 120 includes at least one of a server, a server cluster composed of multiple servers, a cloud computing platform, and a virtualization center. The server 120 is configured to provide a background service for the application supporting the three-dimensional virtual environment. In some embodiments, the server 120 undertakes primary computing tasks, and the terminal undertakes secondary computing tasks. Or, the server 120 undertakes secondary computing tasks, and the terminal undertakes primary computing tasks. Or, the server 120 and the terminal perform cooperative computing using a distributed computing architecture.

In a schematic example, the server 120 includes a memory 121, a processor 122, a user account database 123, a battle service module 124, and a user-oriented input/output (I/O) interface 125. The processor 122 is configured to load an instruction stored in the server 120 and process data in the user account database 123 and the battle service module 124. The user account database 123 is configured to store data of a user account used by the first terminal 110, the second terminal 130 and the other terminals, such as an avatar of the user account, a nickname of the user account, a combat effectiveness index of the user account, and a service region where the user account is located. The battle service module 124 is configured to provide a plurality of battle rooms for users to battle, such as a 1V1 battle, a 3V3 battle, or a 5V5 battle. The user-oriented I/O interface 125 is configured to communicate data with the first terminal 110 and/or the second terminal 130 through the wireless network or the wired network.

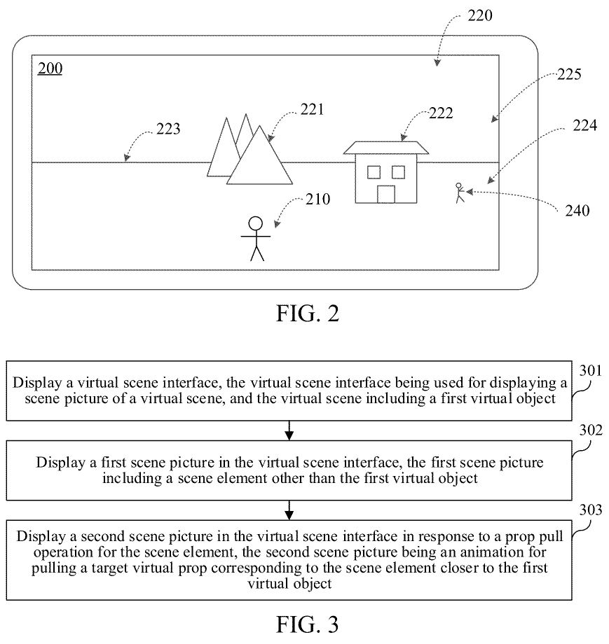

The virtual scene may be a three-dimensional virtual scene, or the virtual scene may be a two-dimensional virtual scene. For example, the virtual scene is the three-dimensional virtual scene. FIG. 2 shows a schematic diagram of a display interface of a virtual scene according to an exemplary embodiment of this application. As shown in FIG. 2, a display interface of a virtual scene includes a scene picture 200. The scene picture 200 includes a currently controlled virtual object 210, an environment picture 220 of a three-dimensional virtual scene, and a virtual object 240. The virtual object 240 may be a user-controlled virtual object or an application-controlled virtual object corresponding to other terminals.

In FIG. 2, the currently controlled virtual object 210 and the virtual object 240 are three-dimensional models in the three-dimensional virtual scene. The environment picture of the three-dimensional virtual scene displayed in the scene picture 200 is an object viewed from the perspective of the currently controlled virtual object 210. Exemplarily, as shown in FIG. 2, the displayed environment picture 220 of the three-dimensional virtual scene includes an earth 224, a sky 225, a horizon 223, a hill 221, and a plant 222 viewed from the perspective of the currently controlled virtual object 210.

The currently controlled virtual object 210 may cast skills, use and move a virtual prop, and execute a specified action under the control of a user. The virtual object in the virtual scene may display different three-dimensional models under the control of the user. For example, a screen of a terminal supports a touch operation, and the scene picture 200 of the virtual scene includes a virtual control. When the user touches the virtual control, the currently controlled virtual object 210 may execute the specified action in the virtual scene and display the currently corresponding three-dimensional model.

FIG. 3 shows a flowchart of a prop control method in a virtual scene according to an exemplary embodiment of this application. The prop control method in the virtual scene may be performed by a computer device. The computer device may be a terminal or a server, or the computer device may include the terminal and the server. As shown in FIG. 3, the prop control method in the virtual scene includes the following steps:

Step 301: Display a virtual scene interface, the virtual scene interface being used for displaying a scene picture of a virtual scene, and the virtual scene including a first virtual object.

In this embodiment of this application, the first virtual object may be a virtual object controlled by a computer device displaying the virtual scene interface.

Step 302: Display a first scene picture in the virtual scene interface, the first scene picture including a scene element other than the first virtual object.

The scene element may be any element corresponding to at least one virtual prop. For example, the scene element may be a virtual prop, or the scene element may be another virtual object equipped with or carrying the virtual prop (such as a virtual character controlled by another player), or the scene element may also be a virtual container storing at least one virtual prop, such as a virtual supply box.

Step 303: Display a second scene picture in the virtual scene interface in response to a prop pull operation for the scene element, the second scene picture being an animation for pulling a target virtual prop corresponding to the scene element closer to the first virtual object.

The first virtual object and the scene element may be spaced apart by a certain distance.

The prop pull operation for the scene element is used for pulling the target virtual prop corresponding to the scene element closer to the first virtual object. Exemplarily, the prop pull operation for the scene element includes: aiming at the scene element with crosshairs and receiving a target operation. Exemplarily, the prop pull operation for the scene element includes a trigger operation for the scene element.

In the related art, in a virtual scene, when a user needs to control a first virtual object to pick up a remote virtual prop or interact with the remote virtual prop, the user needs to first control the first virtual object to move to the vicinity of the virtual prop, and then can perform an operation of picking up or interacting on the virtual prop. Since a moving speed of the first virtual object is limited, when there is an obstacle or a terrain barrier or the first virtual object needs to be covered by an obstacle, the user often needs to control the first virtual object to bypass and approach the virtual prop. Therefore, the process of the user controlling the movement of the first virtual object to the virtual prop generally takes a large amount of time, thereby reducing the human-computer interaction efficiency when the user controls the virtual object to interact with the virtual prop, prolonging the duration of a single battle, and increasing the power consumption and data usage of a computer device.

However, according to the solution shown in this embodiment of this application, with regard to a scene element which is located far away from a first virtual object and corresponds to at least one virtual prop, a user may control the first virtual object to pull a target virtual prop corresponding to the scene element closer to the first virtual object at a relatively high speed. That is to say, in the process of pulling the target virtual prop corresponding to the scene element closer to the first virtual object, a moving speed of the target virtual prop is greater than a moving speed of the first virtual object. In this process, it is not necessary to control the first virtual object to move, whereby the first virtual object may interact with the target virtual prop, for example, pick up the target virtual prop or interact with the target virtual prop.

In summary, according to a prop control solution in a virtual scene provided in this embodiment of this application, when a scene element other than a first virtual object in a virtual scene corresponds to a virtual prop, a target virtual prop corresponding to the scene element may be pulled closer to the first virtual object by performing a prop pull operation, thereby reducing time required by a user to control the first virtual object to approach the target virtual prop, whereby the first virtual object can interact with the virtual prop more quickly. Therefore, the human-computer interaction efficiency when the user controls the virtual object to interact with the virtual prop is greatly improved, thereby shortening the duration of a single battle, and reducing the power consumption and data usage of a computer device.

The embodiment of this application shown in FIG. 3 may be applied to various types of games. A shooting game with a capture-the-flag mode is taken as an example. In the capture-the-flag mode, multiple camps with an adversarial relationship are included (for example, a first camp and a second camp). The first camp and the second camp respectively include one or more virtual objects. The virtual objects of different camps need to capture a flag in the game, whereby the present camp wins the game. For example, a flag may be randomly refreshed in a virtual scene. The virtual objects of different camps may capture the flag and bring it back to specified places (such as bases of the respective camps) to obtain points, and the win-or-lose of the game is determined by the points of the camps. For example, the camp obtaining a target point first wins the game, or the camp obtaining the maximum point at the end of the game wins the game. The points of each flag may be the same, or the points of different flags may be different. The flag may be replaced with other forms of virtual items, such as virtual treasure boxes and virtual resources.

Through the solution provided by the embodiment shown in FIG. 3, in the capture-the-flag mode, when controlling a first virtual object to capture a flag with other virtual objects, a player may pull, by a prop pull operation (such as aiming with crosshairs plus a target operation), a target virtual object from a remote location, including, but not limited to, pulling the flag, a virtual weapon, and other virtual props which may be interacted with the first virtual object from the remote location.

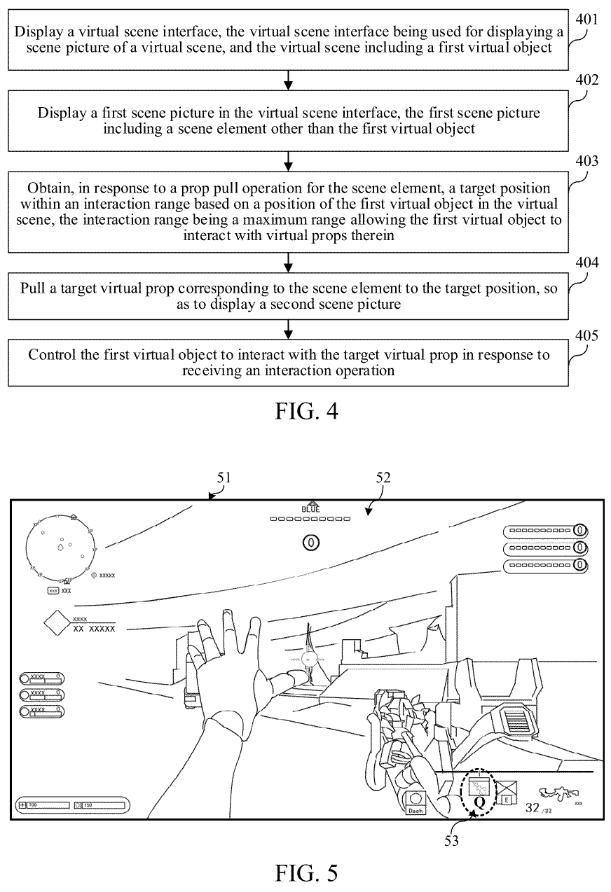

FIG. 4 shows a flowchart of a prop control method in a virtual scene according to an exemplary embodiment of this application. The prop control method in the virtual scene may be performed by a computer device. The computer device may be a terminal or a server, or the computer device may include the terminal and the server. As shown in FIG. 4, the prop control method in the virtual scene includes the following steps:

Step 401: Display a virtual scene interface, the virtual scene interface being used for displaying a scene picture of a virtual scene, and the virtual scene including a first virtual object.

In this embodiment of this application, after a user opens an application (such as an application of a shooting game) corresponding to the virtual scene in a computer device and triggers into the virtual scene, the computer device may display a virtual scene interface therein through the application.

In a possible implementation, the virtual scene interface may include, in addition to the scene picture of the virtual scene, various types of operation controls. The operation controls may be configured to control the virtual scene, such as controlling the first virtual object to act in the virtual scene (for example, throwing, moving, shooting, interacting, and the like), opening or closing a thumbnail map of the virtual scene, exiting the virtual scene, and the like.

Exemplarily, the scene picture displayed in the virtual scene interface may be a picture obtained by observing the virtual scene from a perspective corresponding to the first virtual object, for example, a picture obtained by observing the virtual scene from a first-person perspective or a third-person perspective of the first virtual object.

Step 402: Display a first scene picture in the virtual scene interface, the first scene picture including a scene element other than the first virtual object.

With regard to a scene element which is within the field of view of the first virtual object and corresponds to a virtual prop, the user may control the first virtual object to pull a target virtual prop corresponding to the scene element to the vicinity of the first virtual object, so as to shorten the time for the first virtual object to move to the vicinity of the target virtual prop.

The target virtual prop may be any virtual prop in the virtual scene that may interact with a user-controlled virtual object. For example, the virtual scene is a battle scene. In a battle mode, the target virtual prop may be any virtual prop obtained, equipped, used, or interacted by the first virtual object, and may be, for example, a point prop, a virtual weapon, a virtual ammunition, a virtual resource/resource package, or the like. The point prop refers to a virtual prop having a point which influences the progress of the battle. For example, the point prop may be a flag which is captured by each virtual object in a capture-the-flag mode, or the like.

In this embodiment of this application, a second scene picture is displayed in the virtual scene interface in response to a prop pull operation for the scene element. The second scene picture is an animation for pulling a target virtual prop corresponding to the scene element closer to the first virtual object. For this process, refer to subsequent step 403 and step 404.

Step 403: Obtain, in response to a prop pull operation for the scene element, a target position within an interaction range based on a position of the first virtual object in the virtual scene, the interaction range being a maximum range allowing the first virtual object to interact with virtual props therein.

Exemplarily, the prop pull operation for the scene element includes a trigger operation for the scene element.

Exemplarily, the prop pull operation for the scene element includes: aiming at the scene element with crosshairs and receiving a target operation. The target operation may be an operation of triggering to pull the target virtual prop. For example, the trigger operation may be a shortcut key pressing operation (such as pressing a virtual shortcut key or an entity shortcut key on a keyboard), an operation of pressing and releasing a shortcut key, a slide operation performed from the target position (such as a region where a virtual shortcut key is located), or the like. The operation form of the target operation is not limited in this embodiment of this application.

In this embodiment of this application, a pattern of crosshairs may be displayed in the scene picture of the virtual scene. The crosshairs may indicate a current orientation of the first virtual object. The user may select a scene element by adjusting the pointing direction of the crosshairs, and pull a target virtual prop corresponding to the scene element pointed by the crosshairs by performing the target operation.

After the user points to a scene element through the crosshairs and performs the target operation, the computer device may first determine a target position where the target virtual prop is pulled. The target position is within the interaction range of the first virtual object. That is to say, when the target virtual prop is pulled to the target position, the first virtual object may interact with the target virtual prop without moving.

Exemplarily, the interaction between the first virtual object and the virtual prop in the interaction range includes: at least one of pickup and usage operations performed by the first virtual object on the virtual prop in the interaction range. That is to say, the first virtual object may pick up the virtual prop in the interaction range, may use the virtual prop in the interaction range, or may pick up and use the virtual prop in the interaction range. In some embodiments, the usage of the virtual prop in the interaction range may also be referred to as interaction with the virtual prop within the interaction range.

For example, the interaction range may be a circular region range centered on the first virtual object. A radius of the circular region range is a maximum range of interaction between the first virtual object and the target virtual prop. That is to say, a distance between the target position and the first virtual object is not greater than the radius r of the circular region range. For example, the target position may be directly in front of the first virtual object, and the distance between the target position and the first virtual object is r or r/2.

In a possible implementation, the obtaining, in response to a prop pull operation for the scene element, a target position within an interaction range based on a position of the first virtual object in the virtual scene includes:

obtaining the target position within the interaction range based on the position of the first virtual object in the virtual scene in response to the absence of an obstacle between the scene element and the first virtual object and in response to the prop pull operation for the scene element.

In this embodiment of this application, the absence of an obstacle between the scene element and the first virtual object means that a moving path of the target virtual prop does not pass through the obstacle in the process of pulling the target virtual prop corresponding to the scene element to the vicinity of the first virtual object.

In the virtual scene, there may be some cases in which the scene element is within the field of view of the first virtual object but the scene element and the first virtual object may be covered by other objects. For example, the scene element and the first virtual object are blocked by a glass wall or a wire mesh, or the scene element and the first virtual object are blocked by a short wall.

Since the virtual prop typically has a certain collision volume, when the scene element and the first virtual object are blocked by a glass wall or a wire mesh, the target virtual prop cannot be directly pulled to the vicinity of the first virtual object. At this moment, it is considered that an obstacle is present between the first virtual object and the scene element. In addition, when there is a short wall between the scene element and the first virtual object, if the target virtual prop is pulled closer to the first virtual object in a linear manner, the moving path of the target virtual prop being pulled close passes through the short wall due to the presence of the collision volume. That is to say, the way of the target virtual prop being pulled close is blocked by the short wall. At this moment, it is considered that there is an obstacle between the first virtual object and the scene element.

When there is a short wall between the scene element and the first virtual object, if the target virtual prop is pulled closer to the first virtual object in a parabolic manner, a moving trajectory of the target virtual prop being pulled close does not pass through the short wall. Then the target virtual prop is not blocked by the short wall. At this moment, it may be considered that there is no obstacle between the first virtual object and the scene element.

In addition, if the scene element and the first virtual object are not covered by other objects, it is considered that there is no obstacle between the first virtual object and the scene element.

In a possible implementation, the obtaining, in response to a prop pull operation for the scene element, a target position within an interaction range based on a position of the first virtual object in the virtual scene includes:

obtaining the target position within the interaction range based on the position of the first virtual object in the virtual scene in response to aiming at the scene element with crosshairs and receiving an operation of casting a prop pull skill. That is to say, the prop pull operation includes: aiming at the scene element with crosshairs and receiving an operation of casting a prop pull skill. Exemplarily, the prop pull skill may also be referred to as a target skill.

In this embodiment of this application, the user may trigger the first virtual object to pull the target virtual prop thereto by casting the prop pull skill.

For example, when the first virtual object may use the prop pull skill, a skill control displaying the prop pull skill may be superimposed in the scene interface, and the casting operation may be a trigger operation on the skill control.

Or, when the first virtual object may use the prop pull skill, a casting prompt displaying the prop pull skill may be superimposed in the scene interface. For example, an icon displaying the prop pull skill may be superimposed, and the icon displaying the prop pull skill may indicate a casting key of the prop pull skill. For example, the icon of the prop pull skill includes letter “Q”, which identifies that the user presses key “Q” on a keyboard to trigger the first virtual object to cast the prop pull skill. That is to say, the casting operation may be a pressing operation on key “Q”.

For example, FIG. 5 shows a schematic diagram of skill icon display according to an embodiment of this application. As shown in FIG. 5, a scene picture 52 is displayed in a scene interface 51. An upper layer of the scene picture 52 is superimposed and displayed with a skill icon 53. The skill icon 53 indicates whether the first virtual object may cast the prop pull skill, and indicates a trigger key (Q) for the prop pull skill.

In a possible implementation, before the obtaining, in response to a prop pull operation for the scene element and the first virtual object having a prop pull skill, a target position within an interaction range based on a position of the first virtual object in the virtual scene, the method further includes:

unlocking the prop pull skill for the first virtual object in response to the first virtual object performing a skill unlocking behavior in the virtual scene.

In this embodiment of this application, the prop pull skill may be a skill obtained by performing the skill unlocking behavior during the activity of the first virtual object in the virtual scene. Exemplarily, the skill unlocking behavior may also be referred to as a target behavior.

In a possible implementation, the skill unlocking behavior includes at least one of the following behaviors:

1) Complete a reference-type interaction with a virtual item in the virtual scene.

Exemplarily, the completing a reference-type interaction with a virtual item in the virtual scene may refer to repairing the virtual item, destroying the virtual item, hitting the virtual item, or the like. The reference-type interaction is not limited in this embodiment of this application.

Exemplarily, the virtual item may be any element in the virtual scene, such as a virtual building, a virtual aircraft, a virtual animal, or a virtual plant. Exemplarily, the virtual item may also be referred to as a target item.

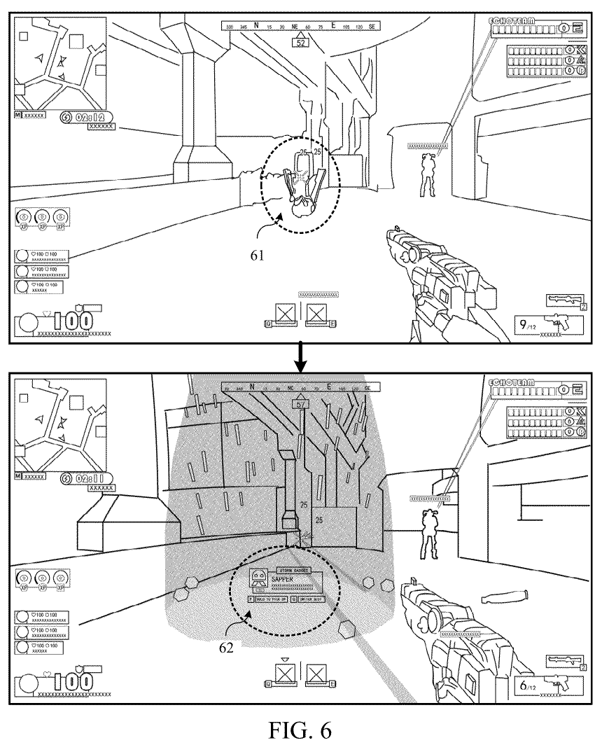

For example, the reference-type interaction is to destroy the virtual item. FIG. 6 is a schematic diagram of a reference-type interaction according to an embodiment of this application. As shown in FIG. 6, the user may control the first virtual object to shoot a virtual item 61 (such as a virtual aircraft). When the first virtual object destroys the virtual item 61 by shooting, a dropped skill prop 62 is refreshed at the position of the virtual item 61 in the virtual scene. The first virtual object may pick up the skill prop 62 and equip (such as picking up and equipping by pressing key F on the keyboard) a prop pull skill corresponding to the skill prop 62.

2) Complete a skill unlocking task in the virtual scene.

In this embodiment of this application, the user may also obtain the prop pull skill by controlling the first virtual object to complete a skill unlocking task in the virtual scene. For example, the skill unlocking task may be a task of placing a particular prop at a particular position, a task of eliminating a specified number of other virtual objects, or the like. The type of the skill unlocking task is not limited in this embodiment of this application. Exemplarily, the skill unlocking task may also be referred to as a target task.

3) Collect virtual props or virtual resources corresponding to the prop pull skill in the virtual scene.

In this embodiment of this application, the user may also obtain the prop pull skill by controlling the first virtual object to collect virtual props or virtual resources corresponding to the prop pull skill in the virtual scene. For example, the virtual props or virtual resources corresponding to the prop pull skill may be scattered in the virtual scene, and may be found and picked up/collected by the first virtual object under the control of the user.

In some embodiments, the prop pull skill may also be an own skill of the first virtual object. For example, the prop pull skill may be an own skill of a virtual object having a particular identity in the virtual scene.

In a possible implementation, the obtaining, in response to a prop pull operation for the scene element, a target position within an interaction range based on a position of the first virtual object in the virtual scene includes:
obtaining a distance between the scene element and the first virtual object in response to the prop pull operation for the scene element; and
obtaining the target position within the interaction range based on the position of the first virtual object in the virtual scene in response to the distance between the scene element and the first virtual object being less than a distance threshold. The distance threshold is used for constraining a maximum distance between a virtual prop pullable by the first virtual object and the first virtual object. The distance threshold may be set according to experience or may be flexibly adjusted according to application scenes. This embodiment of this application is not limited thereto.

In some embodiments, the distance threshold may be greater than the radius of the interaction range in response to the interaction range being the circular region range centered on the first virtual object.

In this embodiment of this application, there is a certain limit to the distance of pulling the target virtual prop by the first virtual object. That is to say, when the distance between the first virtual object and the scene element is less than the distance threshold, the first virtual object may only execute the action of pulling the target virtual prop corresponding to the scene element close. Conversely, if the distance between the first virtual object and the scene element is not less than the distance threshold, the first virtual object cannot execute the action of pulling the target virtual prop corresponding to the scene element close. By limiting the distance, the normalization of the virtual prop pull process can be improved.

In a possible implementation, a first prompt is displayed based on the scene element in response to the distance between the scene element and the first virtual object being less than the distance threshold. The first prompt is used for prompting that the target virtual prop corresponding to the scene element is allowed to be pulled. Exemplarily, the first prompt is directly displayed based on the scene element in response to the distance between the scene element and the first virtual object being less than the distance threshold. Exemplarily, the first prompt is displayed based on the scene element in response to the scene element being aimed with crosshairs and the distance between the scene element and the first virtual object being less than the distance threshold.

In this embodiment of this application, when the user controls the crosshairs to aim at the scene element, if the distance between the scene element and the first virtual object is less than the distance threshold, the computer device may display prompt information based on the scene element, so as to prompt the user that the current distance may be suitable for performing the operation of pulling the target virtual prop, thereby improving the success rate of the operation of controlling, by the user, the first virtual object to pull the target virtual prop close.

Exemplarily, the first prompt may be a prompt pattern superimposed and displayed on the scene element or displayed around the scene element. For example, the first prompt may be a green circular pattern or the like. The first prompt may be prompt text superimposed and displayed on the scene element or displayed around the scene element. For example, the first prompt may be “pull-allowed” text or the like. The display form of the first prompt is not limited in this embodiment of this application.

In a possible implementation, a second prompt is displayed based on the scene element in response to the distance between the scene element and the first virtual object being not less than the distance threshold. The second prompt is used for prompting that the target virtual prop corresponding to the scene element is not allowed to be pulled. Exemplarily, the second prompt is directly displayed based on the scene element in response to the distance between the scene element and the first virtual object being not less than the distance threshold. Exemplarily, the second prompt is displayed based on the scene element in response to the scene element being aimed with crosshairs and the distance between the scene element and the first virtual object being not less than the distance threshold.

In this embodiment of this application, when the user controls the crosshairs to aim at the scene element, if the distance between the scene element and the first virtual object is not less than the distance threshold, the computer device may display another prompt information based on the scene element, so as to prompt the user that the current distance is not suitable for performing the operation of pulling the target virtual prop.

Exemplarily, the second prompt may be a prompt pattern superimposed and displayed on the scene element or displayed around the scene element. For example, the first prompt may be a red circular pattern or the like. The first prompt may be prompt text superimposed and displayed on the scene element or displayed around the scene element. For example, the first prompt may be “pull-not allowed” text. The display form of the second prompt is not limited in this embodiment of this application, and it is only necessary to ensure that the second prompt is different from the first prompt.

Exemplarily, the first prompt or the second prompt may be displayed when the scene element is aimed by the crosshairs, or may be displayed after the scene element is aimed by the crosshairs and a specified operation is received. For example, when the scene element is aimed by the crosshairs and an operation of pressing, by the user, a specified key (such as key T) is received, the computer device may display the first prompt or the second prompt.

In a possible implementation, the specified operation may be a preceding operation of the target operation. For example, assuming that the target operation is an operation of clicking/tapping a skill key, the operation of clicking/tapping a skill key includes two steps: pressing the skill key and releasing the skill key. The operation of pressing the skill key may be the specified operation.

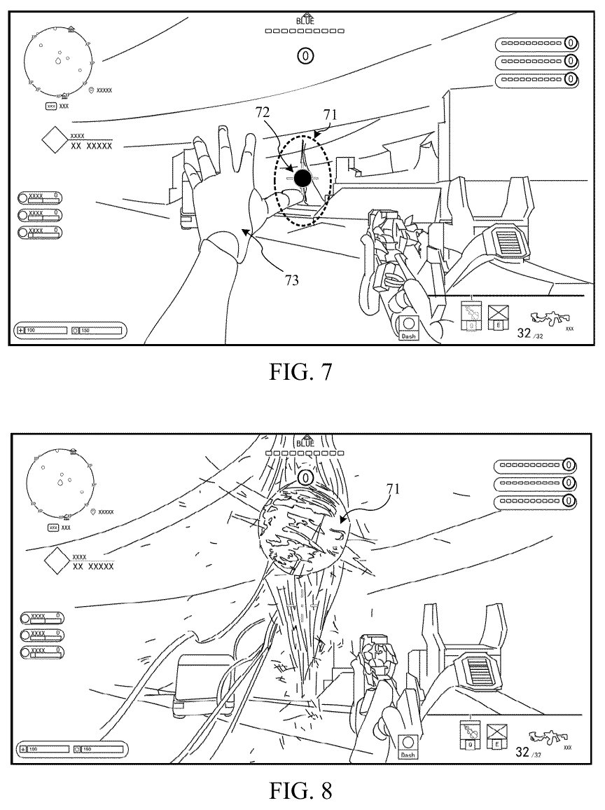

For example, FIG. 7 shows a schematic diagram of prompt information display according to an embodiment of this application. As shown in FIG. 7, when the user controls the crosshairs to aim at the vicinity of a scene element 71, a prompt pattern 72 is superimposed and displayed on the scene element 71. When the distance between the scene element and the first virtual object is less than the distance threshold, the prompt pattern 72 may be displayed in green, and the user may be prompted to directly pull a target virtual prop corresponding to the scene element. When the distance between the scene element and the first virtual object is not less than the distance threshold, the prompt pattern 72 may be displayed in red, and the user may be prompted that the current scene element is too far and the target virtual prop corresponding to the scene element cannot be directly pulled.

Step 404: Pull a target virtual prop corresponding to the scene element to the target position, so as to display a second scene picture.

In a possible implementation, the target virtual prop is the scene element.

In a schematic solution of this embodiment of this application, the scene element is a virtual prop that may be interacted by the first virtual object. For example, the scene element is a virtual prop that may be picked up or interacted by the first virtual object. For example, the scene element may be a point prop (such as a flag in a capture-the-flag mode), a virtual weapon, a virtual resource, or the like. The user may control the first virtual object to directly pull a remotely visible target virtual prop in the virtual scene to a near place so as to quickly control the first virtual object to pick up or interact.

For example, FIG. 7 shows a schematic diagram of virtual prop pull according to an embodiment of this application. It is assumed that in FIG. 7, the user controls the crosshairs to aim at the scene element 71 and the prompt pattern 72 is displayed in green. At this moment, the user performs a prop pull operation, and the computer device controls a hand 73 of the first virtual object to execute a pull action. Then, as shown in FIG. 8, the scene element 71 is pulled to the vicinity of the first virtual object as the target virtual prop.

That is to say, when a player-controlled character faces a specified prop and a distance between the player character and the prop is less than a skill casting distance, the player holds a skill casting key, and a green executable mark appears in front of the specified prop. If the distance between the player and the prop is greater than or equal to the casting distance, a red non-executable mark appears in front of the prop. If the player and the prop are covered by an obstacle, the skill cannot achieve aiming and cannot be used. When the prop pull skill is in an executable state, the player releases the skill casting key in the held state, the skill is cast, and the specified prop is pulled to the front of the player character. In some embodiments, after the prop pull skill is cast successfully, a cooling time of the prop pull skill restarts to be calculated.

In a possible implementation, the scene element is a second virtual object carrying or equipped with the target virtual prop.

In a schematic solution of this embodiment of this application, the scene element may be another virtual object (such as a virtual character controlled by another player) equipped with or carrying a virtual prop.

In this embodiment of this application, the user may also remotely pull the target virtual prop from another virtual object in the virtual scene by controlling the first virtual object.

Exemplarily, the second virtual object may be a teammate in the same camp as the first virtual object, or may also be another virtual object in a different camp (such as an opposing camp or a neutral camp) from the first virtual object. For example, in the capture-the-flag mode, a carried flag or an equipped weapon or the like may be pulled from the virtual object in the opposing camp.

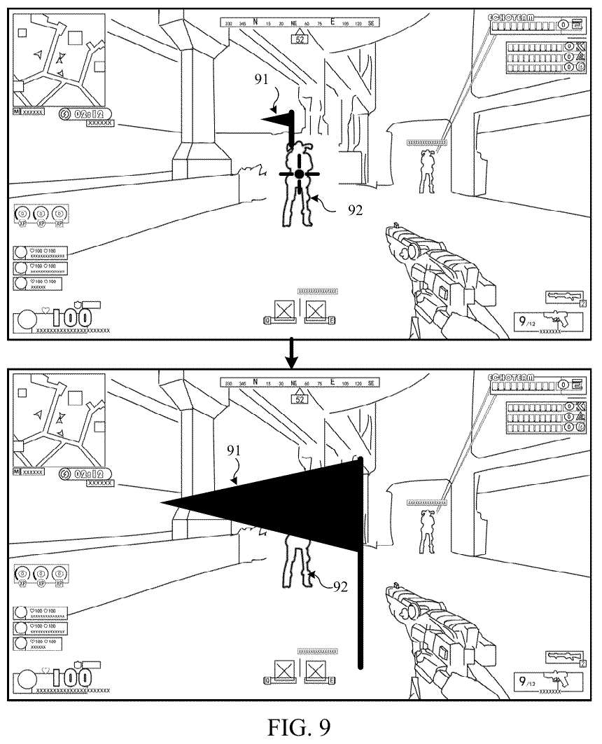

For example, FIG. 9 shows a schematic diagram of virtual prop pull according to an embodiment of this application. As shown in FIG. 9, a shooting game scene in a capture-the-flag mode is taken as an example. A second virtual object 92 carries a flag 91. After aiming at the second virtual object 92 with the crosshairs of the first virtual object under the control of the player, a target operation (such as pressing key Q) is performed. At this moment, the flag 91 on the second virtual object 92 will be pulled to the vicinity of the first virtual object, whereby the player may control the first virtual object to directly pick up the flag 91.

In some embodiments, when the scene element is a second virtual object carrying or equipped with a target virtual prop, a state value of the second virtual object is obtained in response to a prop pull operation for the second virtual object. The second scene picture is displayed in the virtual scene interface in response to the state value satisfying a prop pull condition. Exemplarily, the prop pull operation for the second virtual object includes: aiming at the second virtual object with crosshairs and receiving the target operation. Exemplarily, the prop pull operation for the second virtual object includes a trigger operation for the second virtual object.

In this embodiment of this application, when the scene element is the second virtual object, if the state value of the second virtual object satisfies a pull condition, the first virtual object may pull the target virtual prop carried thereby from the second virtual object by a prop pull operation (such as aiming with crosshairs plus the target operation).

Exemplarily, the state value may indicate a state of the second virtual object. The prop pull condition may be preset by a developer.

For example, the state may directly indicate whether the target virtual prop on the second virtual object is allowed to be pulled. For example, when the state value is 1, it is represented that the target virtual prop on the second virtual object is allowed to be pulled. That is to say, it is represented that the state value satisfies the prop pull condition. When the state value is 0, it is represented that the target virtual prop on the second virtual object is not allowed to be pulled. That is to say, it is represented that the state value does not satisfy the prop pull condition. At this moment, the state may be determined by other information of the second virtual object, for example, may be determined by whether the second virtual object has a gain state or prop for masking the target virtual prop being pulled, or may be determined by a health state of the second virtual object (such as a life value or a physical strength value).

Or, the state may also indirectly indicate whether the target virtual prop on the second virtual object is allowed to be pulled. For example, the state is a ratio state of the life value/physical strength value of the second virtual object. When the life value/physical strength value (state value) of the second virtual object is less than a certain ratio threshold (such as less than 50%), it is represented that the target virtual prop on the second virtual object is allowed to be pulled, namely, that the state value satisfies the prop pull condition. Otherwise, it is represented that the target virtual prop on the second virtual object is not allowed to be pulled, namely, that the state value does not satisfy the prop pull condition.

In a possible implementation, the scene element is a virtual container storing the target virtual prop.

In a schematic solution of this embodiment of this application, the scene element may also be a virtual container storing at least one virtual prop, such as a virtual supply box.

In this embodiment of this application, the user may also remotely pull the target virtual prop from the virtual container in the virtual scene by controlling the first virtual object.

In a possible implementation, the target virtual prop is a virtual prop randomly chosen from at least two virtual props corresponding to the scene element.

Or, the target virtual prop is a virtual prop from at least two virtual props having a specific type corresponding to the scene element.

Or, the target virtual prop is a virtual prop from at least two virtual props having a top priority corresponding to the scene element.

In this embodiment of this application, if the scene element corresponds to two or more virtual props, for example, the scene element is another virtual object or a virtual container, when the user controls the first virtual object to perform the prop pull operation on the scene element, the computer device may select one virtual prop from the two or more virtual props corresponding to the scene element as the target virtual prop. The computer device may randomly select the target virtual prop, or select the target virtual prop according to a prop type, or select the target virtual prop according to priority.

In some embodiments, when selecting the target virtual prop according to the prop type, if the number of virtual props of a specific type in at least two virtual props corresponding to the scene element is greater than 1, the computer device may randomly select one virtual prop from the virtual props of the specific type, or select one virtual prop according to a ranking order as the target virtual prop.

Exemplarily, the specific type may be a preset prop type, or the specific type may be a prop type preset by the user, or the specific type may be a prop type determined by the user when performing the prop pull operation. Or, when the scene element is a second virtual object, the specific type may also be a prop type determined by the identity of the second virtual object in the virtual scene. Exemplarily, the specific type may also be referred to as a target type.

For example, when the specific type is a prop type preset by the user, the user may open a prop type setting interface before or during the running of the virtual scene, and set the specific type in the prop type setting interface. For example, an ammunition type or a medical type is set as the specific type. Subsequently during the running of the virtual scene, when the user controls the first virtual object to perform the prop pull operation on the scene element, the computer device may control the first virtual object to pull the target virtual prop of the specific type set by the user. For example, it is assumed that the specific type set by the user is an ammunition type. When the user controls the first virtual object to perform the prop pull operation on the scene element, the computer device controls the first virtual object to pull a virtual ammunition matched with a current weapon of the first virtual object from the virtual prop corresponding to the scene element.

For another example, if the specific type is a prop type determined by the user when performing the prop pull operation, during the running of the virtual scene, when the user controls the first virtual object to perform the prop pull operation on the scene element, or before the user controls the first virtual object to perform the prop pull operation on the scene element, options of at least two candidate prop types may be popped, and a prop type corresponding to one of the options may be selected by the user as the specific type. For example, when the user controls the first virtual object to perform the prop pull operation on the scene element, the user selects an option of a medical type from the popped options of candidate prop types, and the computer device controls the first virtual object to pull a virtual medical kit from the virtual prop corresponding to the scene element.

Similarly, when selecting the target virtual prop according to the priority, if the number of top-priority virtual props in at least two virtual props corresponding to the scene element is greater than 1, the computer device may randomly select one virtual prop from the top-priority virtual props, or select one virtual prop according to a ranking order as the target virtual prop.

For another example, when the specific type is a prop type determined by the identity of the second virtual object in the virtual scene, assuming that the second virtual object is a medical soldier, the specific type may be a medical type (corresponding to the medical kit, etc.), and assuming that the second virtual object is a supply soldier, the specific type may be an ammunition type (corresponding to the virtual ammunition).

In a possible implementation, when the scene element is the second virtual object in the virtual scene, the priority may be determined according to a placement position of the virtual prop. The placement position is a position corresponding to multiple different prop placement columns of a virtual object. For example, the prop placement columns may be divided into a main weapon column (used for equipping a current main weapon), a secondary weapon column (used for equipping a current secondary weapon), a shortcut key column (used for equipping a shortcut prop, such as a medical kit or a throwing prop), a backpack column (used for storing non-equipped props), and the like. The priority of the main weapon column is the highest, the priority of the secondary weapon column is the second highest, and so on. When the user controls the first virtual object to perform the prop pull operation on the second virtual object, the second virtual object is equipped with a main weapon, and the main weapon equipped in the second virtual object is preferentially pulled. If the second virtual object is not equipped with the main weapon but only with a secondary weapon, the secondary weapon equipped in the second virtual object is preferentially pulled.

In a possible implementation, when the scene element is the virtual container in the virtual scene, the priority may be determined according to the types of the virtual props. The computer device stores correspondences between the types of the virtual props and the priority. According to the types of the virtual props in the virtual container, the priority of the virtual props in the virtual container can be determined, and then the top-priority virtual prop is taken as the target virtual prop. The correspondences between the types of the virtual props and the priority may be preset by the developer.

In a possible implementation, in response to the presence of an obstacle between the scene element and the first virtual object, the target virtual prop is pulled to the other side of the obstacle relative to the first virtual object.

In this embodiment of this application, if an obstacle is present between the scene element and the first virtual object and the scene element is within the field of view of the first virtual object, when the user controls the first virtual object to perform the prop pull operation on the scene element, the computer device may control the first virtual object to pull the target virtual prop, and when the target virtual prop moves towards the first virtual object, the target virtual prop stops moving at a position of collision with the obstacle. That is to say, in response to the presence of an obstacle between the scene element and the first virtual object, the target virtual prop is pulled to a position of collision with the obstacle.

Step 405: Control the first virtual object to interact with the target virtual prop in response to receiving an interaction operation.

In this embodiment of this application, when the target virtual prop is pulled to the interaction range of the first virtual object, the user may control the first virtual object to interact with the target virtual prop, for example, pick up the target virtual prop, or interact with the target virtual prop.

In summary, according to a prop control solution in a virtual scene provided in this embodiment of this application, when a scene element other than a first virtual object in a virtual scene corresponds to a virtual prop, a target virtual prop corresponding to the scene element may be pulled closer to the first virtual object by performing a prop pull operation, thereby reducing time required by a user to control the first virtual object to approach the target virtual prop, whereby the first virtual object can interact with the virtual prop more quickly. Therefore, the human-computer interaction efficiency when the user controls the virtual object to interact with the virtual prop is greatly improved, thereby shortening the duration of a single battle, and reducing the power consumption and data usage of a computer device.

In addition, the target virtual prop may be a prop carried or equipped by another virtual object, so as to improve the efficiency of obtaining props carried or equipped by other virtual objects. For example, the efficiency of transferring props with teammates is improved, or the efficiency of stealing props from opponents, and the interaction experience of the user is improved, thereby improving the interaction rate.

Furthermore, when a distance between the scene element and the first virtual object is less than a distance threshold, a subsequent virtual prop pull process is performed, which is beneficial to improve the normalization of the prop pull process. A first/second prompt is displayed to inform whether the user is allowed to pull the target virtual prop, which is beneficial to improve the success rate of an operation of controlling, by the user, the first virtual object to pull the target virtual prop close.

For example, in a game scene, the foregoing embodiments of this application provide a skill available in a game. By using this skill, a player may quickly pull a specified prop (namely, the target virtual prop) to the front of a player character (namely, the first virtual object). The specified prop may be either a prop generated on a map, or a prop already picked up on an opponent or a teammate, or may also be a prop stored in a virtual container such as a supply box. The skill may save the time during which the player previously needs to control the player character to pick up the prop at the vicinity thereof. When acting on the teammate, the effect of quickly transferring props is achieved. When acting on the opponent, the effect of quickly stealing props is achieved.

In the related art, the player who wants to pick up a specified prop or item can only pick/interact by moving into a prop pickable range, which takes a certain amount of time. Also, if the prop is moving, the player may spend some time chasing. In the process of moving or chasing, the time for the player is actually consumed, which prolongs the time of a single game, thereby increasing the power consumption and data usage of the computer device.

In addition, in general, if the player wants to obtain props on the opponent, the player needs to defeat the opponent to pick up the props. By using the skill provided in this application, the specified prop may be stolen directly from the player, thereby greatly shortening the battle time. Also, if there are such props on the teammate, the teammate generally needs to throw the props to the ground, and the player runs to the place where the props are placed for picking. However, by using this skill, the props may be obtained directly from the teammate, thereby shortening the “throw-run-pick” time.

That is to say, the skill provided in the foregoing embodiments of this application will greatly shorten the time for the player to move to the position of the prop, shorten the time for a single game, and speed up the rhythm of the single game. For example, in a general shooting game, it is required to defeat an opponent to obtain props on the opponent. By using this skill, the props may be pulled directly from the opponent without defeating the opponent. Or, a specific prop may be obtained from a teammate, thereby achieving the effect of quick transfer.

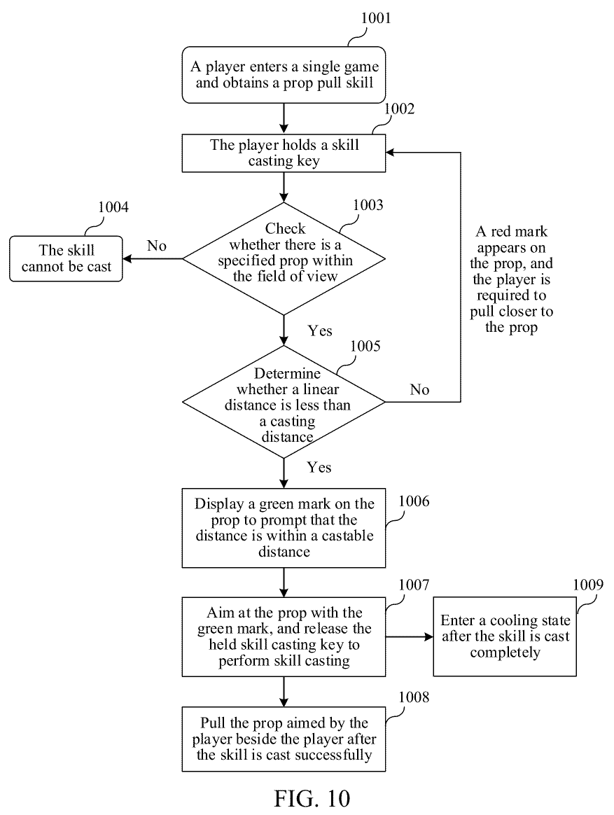

A game scene is taken as an example. FIG. 10 is a control flowchart of virtual prop pull according to an exemplary embodiment. As shown in FIG. 10, the control flow of virtual prop pull may be as follows:

S1001: A player enters a single game and obtains a prop pull skill.

S1002: The player holds a skill casting key.

S1003: Check whether there is a specified prop within the field of view of the player. If yes, the flow proceeds to S1005, and otherwise, the flow proceeds to S1004.

S1004: If there is no specified prop within the field of view of the player, the skill cannot be cast.

S1005: Determine whether a linear distance between the prop and the player is less than a casting distance of the skill in the presence of the specified prop in the field of view of the player. If yes, the flow proceeds to S1006, and otherwise, the flow returns to S1002.

If the distance is not less than the casting distance, a red mark appears on the prop. At this moment, the skill cannot be cast, and the player is required to pull closer to the prop.

S1006: Display a green mark on the prop to prompt that the distance is within a castable distance if the distance is less than the casting distance of the skill.

S1007: The player aims at the prop with the green mark, and releases the held skill casting key to perform skill casting.

S1008: Pull the prop aimed by the player beside the player after the skill is cast successfully.

S1009: Enter a cooling state after the skill is cast completely, and re-cast the skill after the cooling ends.

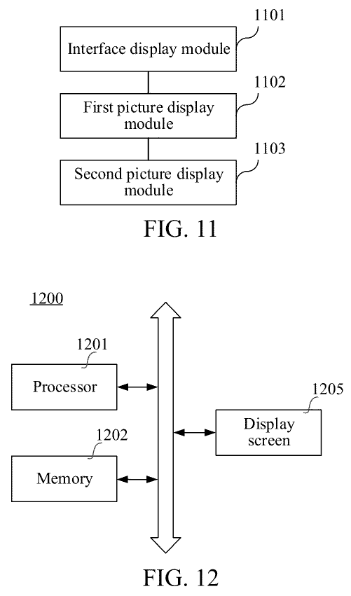

FIG. 11 shows a block diagram of a prop control apparatus in a virtual scene according to an exemplary embodiment of this application. The prop control apparatus in the virtual scene may be applied in a computer device to perform all or some steps of the method as shown in FIG. 3 or FIG. 4. As shown in FIG. 11, the prop control apparatus in the virtual scene includes:
an interface display module 1101, configured to display a virtual scene interface, the virtual scene interface being used for displaying a scene picture of a virtual scene, and the virtual scene including a first virtual object;
a first picture display module 1102, configured to display a first scene picture in the virtual scene interface, the first scene picture including a scene element other than the first virtual object; and
a second picture display module 1103, configured to display a second scene picture in the virtual scene interface in response to a prop pull operation for the scene element, the second scene picture being an animation for pulling a target virtual prop corresponding to the scene element closer to the first virtual object.

In a possible implementation, the target virtual prop is the scene element.

In a possible implementation, the scene element is a second virtual object carrying or equipped with the target virtual prop.

In a possible implementation, the second picture display module 1103 is configured to: obtain a state value of the second virtual object in response to a prop pull operation for the second virtual object; and display the second scene picture in the virtual scene interface in response to the state value satisfying a prop pull condition.

In a possible implementation, the scene element is a virtual container storing the target virtual prop.

In a possible implementation, the target virtual prop is a virtual prop randomly chosen from at least two virtual props corresponding to the scene element; or, the target virtual prop is a virtual prop from at least two virtual props having a specific type corresponding to the scene element; or, the target virtual prop is a virtual prop from at least two virtual props having a top priority corresponding to the scene element.

In a possible implementation, the second picture display module 1103 is configured to: obtain a target position within an interaction range based on a position of the first virtual object in the virtual scene, the interaction range being a maximum range allowing the first virtual object to interact with virtual props therein; and pull the target virtual prop to the target position, so as to display the second scene picture.

In a possible implementation, the second picture display module 1103 is configured to obtain the target position within the interaction range based on the position of the first virtual object in the virtual scene in response to the absence of an obstacle between the scene element and the first virtual object.

In a possible implementation, the second picture display module 1103 is further configured to pull, in response to the presence of an obstacle between the scene element and the first virtual object, the target virtual prop to a position of collision with the obstacle.

In a possible implementation, the prop pull operation includes: aiming at the scene element with crosshairs and receiving an operation of casting a prop pull skill.

In a possible implementation, the apparatus further includes:

an unlocking module, configured to unlock the prop pull skill for the first virtual object in response to the first virtual object performing a skill unlocking behavior in the virtual scene.

In a possible implementation, the skill unlocking behavior includes at least one of the following behaviors:
completing a reference-type interaction with a virtual item in the virtual scene;
completing a skill unlocking task in the virtual scene; and
collecting virtual props or virtual resources corresponding to the prop pull skill in the virtual scene.

In a possible implementation, the second picture display module 1103 is configured to: obtain a distance between the scene element and the first virtual object; and obtain the target position within the interaction range based on the position of the first virtual object in the virtual scene in response to the distance between the scene element and the first virtual object being less than a distance threshold.

In a possible implementation, the apparatus further includes:

a first prompt module, configured to display a first prompt based on the scene element in response to the distance between the scene element and the first virtual object being less than the distance threshold. The first prompt is used for prompting that the target virtual prop corresponding to the scene element is allowed to be pulled.

In a possible implementation, the apparatus further includes:

a second prompt module, configured to display a second prompt based on the scene element in response to the distance between the scene element and the first virtual object being not less than the distance threshold. The second prompt is used for prompting that the target virtual prop corresponding to the scene element is not allowed to be pulled.

In a possible implementation, the interaction between the first virtual object and the virtual prop in the interaction range includes: at least one of pickup and usage operations performed by the first virtual object on the virtual prop in the interaction range.

In summary, according to a prop control solution in a virtual scene provided in this embodiment of this application, when a scene element other than a first virtual object in a virtual scene corresponds to a virtual prop, a target virtual prop corresponding to the scene element may be pulled closer to the first virtual object by performing a prop pull operation, thereby reducing time required by a user to control the first virtual object to approach the target virtual prop, whereby the first virtual object can interact with the virtual prop more quickly. Therefore, the human-computer interaction efficiency when the user controls the virtual object to interact with the virtual prop is greatly improved, thereby shortening the duration of a single battle, and reducing the power consumption and data usage of a computer device.

In addition, the target virtual prop may be a prop carried or equipped by another virtual object, so as to improve the efficiency of obtaining props carried or equipped by other virtual objects. For example, the efficiency of transferring props with teammates is improved, or the efficiency of stealing props from opponents, and the interaction experience of the user is improved, thereby improving the interaction rate.

Furthermore, when a distance between the scene element and the first virtual object is less than a distance threshold, a subsequent virtual prop pull process is performed, which is beneficial to improve the normalization of the prop pull process. A first/second prompt is displayed to inform whether the user is allowed to pull the target virtual prop, which is beneficial to improve the success rate of an operation of controlling, by the user, the first virtual object to pull the target virtual prop close.

FIG. 12 shows a structural block diagram of a computer device 1200 according to an exemplary embodiment of this application. The computer device 1200 may be a portable mobile terminal, such as a smartphone, a tablet computer, an MP3 player, an MP4 player, a laptop computer, or a desktop computer. The terminal device 1200 may also be referred to as another name such as a user equipment, a portable terminal, a laptop terminal, or a desktop terminal.

Generally, the computer device 1200 includes: a processor 1201 and a memory 1202.

The processor 1201 may include one or more processing cores, such as a 4-core processor or an 8-core processor. The processor 1201 may be implemented in at least one hardware form of a digital signal processor (DSP), a field-programmable gate array (FPGA), and a programmable logic array (PLA).

The memory 1202 may include one or more computer-readable storage media. The computer-readable storage medium may be non-transient. The memory 1202 may further include a high-speed random access memory and a nonvolatile memory, for example, one or more disk storage devices or flash storage devices. In some embodiments, the non-transitory computer-readable storage medium in the memory 1202 is configured to store at least one computer instruction. The at least one computer instruction is used for execution by the processor 1201, whereby the computer device 1200 implements the prop control method in the virtual scene according to the method embodiments of this application.

In some embodiments, the computer device 1200 may further optionally include: a display screen 1205. The display screen 1205 is configured to display a virtual scene interface and display a scene picture of a virtual scene in the virtual scene interface, etc.

It is to be understood by a person skilled in the art that the structure shown in FIG. 12 is not limiting of the computer device 1200 and may include more or fewer assemblies than illustrated, or some assemblies may be combined, or different assembly arrangements may be employed.

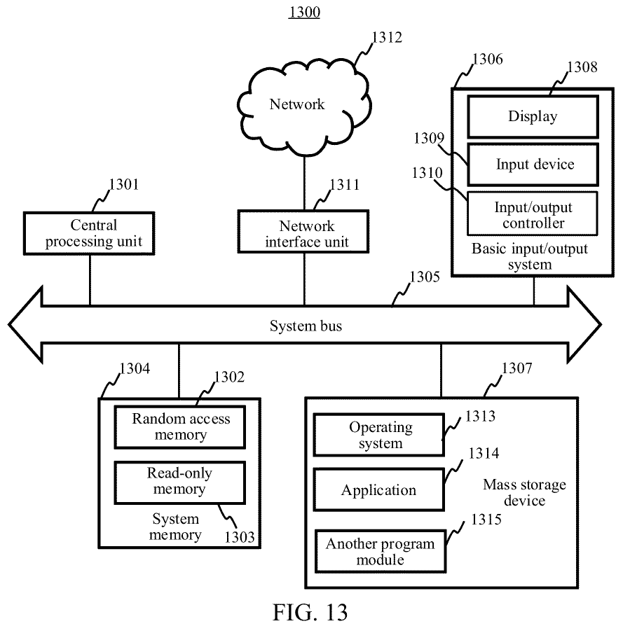

FIG. 13 shows a structural block diagram of a computer device 1300 according to an exemplary embodiment of this application. The computer device 1300 may be implemented as a prop control device in a virtual scene in the foregoing solution of this application. The computer device 1300 includes a central processing unit (CPU) 1301, a system memory 1304 including a random access memory (RAM) 1302 and a read-only memory (ROM) 1303, and a system bus 1305 connecting the system memory 1304 and the CPU 1301. The computer device 1300 further includes a basic I/O system 1306 that facilitates transfer of information between elements within a computer, and a mass storage device 1307 that stores an operating system 1313, an application 1314, and another program module 1315.

The basic I/O system 1306 includes a display 1308 for displaying information and an input device 1309 such as a mouse or a keyboard for inputting information by a user. The display 1308 and the input device 1309 are connected to the CPU 1301 through an I/O controller 1310 which is connected to the system bus 1305. The basic I/O system 1306 may further include the I/O controller 1310 for receiving and processing input from multiple other devices, such as a keyboard, a mouse, or an electronic stylus. Similarly, the I/O controller 1310 also provides output to a display screen, a printer, or another type of output device.

The mass storage device 1307 is connected to the CPU 1301 through a mass storage controller (not shown) connected to the system bus 1305. The mass storage device 1307 and a computer-readable medium associated therewith provide non-transitory storage for the computer device 1300. That is to say, the mass storage device 1307 may include a computer-readable medium (not shown) such as a hard disk or a compact disc read-only memory (CD-ROM) drive.

In general, the computer-readable medium may include a computer storage medium and a communication medium. The computer storage medium includes volatile and non-transitory media, and removable and non-removable media implemented by using any method or technology used for storing information such as computer-readable instructions, data structures, program modules, or other data. The computer storage medium includes a RAM, a ROM, an erasable programmable read only memory (EPROM), an electrically-erasable programmable read-only memory (EEPROM), a flash memory or another solid-state memory technology, a CD-ROM, a digital versatile disc (DVD) or another optical memory, a tape cartridge, a magnetic tape, a magnetic disk memory, or another magnetic storage device. Certainly, a person skilled in the art may learn that the computer storage medium is not limited to the foregoing several types. The foregoing system memory 1304 and mass storage device 1307 may be collectively referred to as a memory.

According to various embodiments of the present disclosure, the computer device 1300 may also operate through a remote computer connected to a network through, for example, the Internet. That is, the computer device 1300 may be connected to a network 1312 through a network interface unit 1311 which is connected to the system bus 1305, or may be connected to another type of network or remote computer system (not shown) by using the network interface unit 1311.

The memory further includes at least one computer instruction. The at least one computer instruction is stored in the memory. The CPU 1301 implements all or some of the steps of the prop control method in the virtual scene shown in the various embodiments by executing the at least one instruction, at least one program, a code set or an instruction set.

In an exemplary embodiment, a non-transitory (which may also be referred to as non-transitory) computer-readable storage medium including instructions is also provided, for example, a memory including at least one computer instruction. The at least one computer instruction is executable by a processor, whereby a computer completes all or some of the steps of the method shown in any embodiment of FIG. 3 or FIG. 4. For example, the non-transitory computer readable storage medium may be a ROM, a RAM, a CD-ROM, a magnetic tape, a floppy disk, an optical data storage device, or the like.

In an exemplary embodiment, a computer program product or a computer program is also provided. The computer program product or the computer program includes computer instructions. The computer instructions are stored in a non-transitory computer-readable storage medium. A processor of a computer device reads the computer instructions from the non-transitory computer-readable storage medium. The processor executes the computer instructions, whereby the computer device performs all or some of the steps of the method shown in any embodiment of FIG. 3 or FIG. 4.

After considering the specification and practicing the present disclosure, a person skilled in the art may easily conceive of other implementations of this application. This application is intended to cover any variations, uses, or adaptive changes of this application, which follow the general principles of this application and include known or customary technological means in the art not disclosed by this application. The specification and the embodiments are considered as merely exemplary, and the true scope of this application is pointed out in the following claims.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. It is to be understood that this application is not limited to the precise structures described above and shown in the accompanying drawings, and various modifications and changes may be made without departing from the scope of this application. The scope of this application is limited only by the appended claims.

What is claimed is:

1. A prop control method in a virtual scene, performed by a computer device, the method comprising:
displaying a first scene picture of the virtual scene, the first scene picture including a first virtual object and a scene element;
when a distance between the first virtual object and the scene element in the virtual scene meets a predefined condition, receiving a prop pull operation for the scene element by the first virtual object; and
in response to the prop pull operation for the scene element, controlling the first virtual object pull a target virtual prop corresponding to the scene element closer to the first virtual object.

2. The method according to claim 1, wherein the target virtual prop is the scene element.

3. The method according to claim 1, wherein the scene element is a second virtual object carrying or equipped with the target virtual prop.

4. The method according to claim 3, wherein the displaying a second scene picture of the virtual scene comprises:
obtaining a state value of the second virtual object in response to a prop pull operation for the second virtual object; and
displaying the second scene picture of the virtual scene in response to the state value satisfying a prop pull condition.

5. The method according to claim 1, wherein the scene element is a virtual container storing the target virtual prop.

6. The method according to claim 1, wherein
the target virtual prop is a virtual prop randomly chosen from at least two virtual props corresponding to the scene element;
or, the target virtual prop is a virtual prop from at least two virtual props having a specific type corresponding to the scene element;
or, the target virtual prop is a virtual prop from at least two virtual props having a top priority corresponding to the scene element.

7. The method according to claim 1, wherein the displaying a second scene picture of the virtual scene comprises:
obtaining a target position within an interaction range based on a position of the first virtual object in the virtual scene, the interaction range being a maximum range allowing the first virtual object to interact with virtual props therein; and
pulling the target virtual prop to the target position, so as to display the second scene picture.

8. A computer device, comprising a processor and a memory, the memory storing at least one computer instruction, and the at least one computer instruction being loaded and executed by the processor, and causing the computer device to implement a prop control method in a virtual scene, the method including:
displaying a first scene picture of the virtual scene, the first scene picture including a first virtual object and a scene element;
when a distance between the first virtual object and the scene element in the virtual scene meets a predefined condition, receiving a prop pull operation for the scene element by the first virtual object; and
in response to the prop pull operation for the scene element, controlling the first virtual object pull a target virtual prop corresponding to the scene element closer to the first virtual object.

9. The computer device according to claim 8, wherein the target virtual prop is the scene element.

10. The computer device according to claim 8, wherein the scene element is a second virtual object carrying or equipped with the target virtual prop.

11. The computer device according to claim 10, wherein the displaying a second scene picture of the virtual scene comprises:
obtaining a state value of the second virtual object in response to a prop pull operation for the second virtual object; and
displaying the second scene picture of the virtual scene in response to the state value satisfying a prop pull condition.

12. The computer device according to claim 8, wherein the scene element is a virtual container storing the target virtual prop.

13. The computer device according to claim 8, wherein
the target virtual prop is a virtual prop randomly chosen from at least two virtual props corresponding to the scene element;
or, the target virtual prop is a virtual prop from at least two virtual props having a specific type corresponding to the scene element;
or, the target virtual prop is a virtual prop from at least two virtual props having a top priority corresponding to the scene element.

14. The computer device according to claim 8, wherein the displaying a second scene picture of the virtual scene comprises:
obtaining a target position within an interaction range based on a position of the first virtual object in the virtual scene, the interaction range being a maximum range allowing the first virtual object to interact with virtual props therein; and
pulling the target virtual prop to the target position, so as to display the second scene picture.

15. A nontransitory computer-readable storage medium, storing at least one computer instruction, and the at least one computer instruction being loaded and executed by a processor of a computer device, and causing the computer device to implement a prop control method in a virtual scene, the method including:
displaying a first scene picture of the virtual scene, the first scene picture including a first virtual object and a scene element;
when a distance between the first virtual object and the scene element in the virtual scene meets a predefined condition, receiving a prop pull operation for the scene element by the first virtual object; and
in response to the prop pull operation for the scene element, controlling the first virtual object pull a target virtual prop corresponding to the scene element closer to the first virtual object.

16. The non-transitory computer-readable storage medium according to claim 15, wherein the target virtual prop is the scene element.

17. The non-transitory computer-readable storage medium according to claim 15, wherein the scene element is a second virtual object carrying or equipped with the target virtual prop.

18. The non-transitory computer-readable storage medium according to claim 17, wherein the displaying a second scene picture of the virtual scene comprises:
obtaining a state value of the second virtual object in response to a prop pull operation for the second virtual object; and
displaying the second scene picture of the virtual scene in response to the state value satisfying a prop pull condition.

19. The non-transitory computer-readable storage medium according to claim 15, wherein the scene element is a virtual container storing the target virtual prop.

20. The non-transitory computer-readable storage medium according to claim 15, wherein the displaying a second scene picture of the virtual scene comprises:
obtaining a target position within an interaction range based on a position of the first virtual object in the virtual scene, the interaction range being a maximum range allowing the first virtual object to interact with virtual props therein; and
pulling the target virtual prop to the target position, so as to display the second scene picture.
